(19) United States
(12) Patent Application Publication
(10) Pub. No.: US 2024/0146587 A1
(43) Pub. Date: May 2, 2024

(54) WIRELESS ACCESS SYSTEM, CENTRALIZED CONTROL STATION, SIGNAL PROCESSING METHOD, AND RECORDING MEDIUM

(71) Applicant: NEC Corporation, Tokyo (JP)

(72) Inventor: Masaaki TANIO, Tokyo (JP)

(73) Assignee: NEC Corporation, Tokyo (JP)

(21) Appl. No.: 18/379,380

(22) Filed: Oct. 12, 2023

(30) Foreign Application Priority Data
Oct. 27, 2022 (JP) 2022-172274

(51) Int. Cl. H04L 27/00; H04L 27/20

(52) U.S. Cl. CPC H04L 27/0008; H04L 27/2096; H04W 88/08

(57) ABSTRACT

A wireless access system includes: a centralized control station; and an access point. The access point performs a pulse width modulation process on an analog uplink signal, thereby to generate an analog modulation signal; and converts the analog modulation signal to an optical uplink signal. The centralized control station converts the optical uplink signal to an electrical uplink signal; performs, on the electrical uplink signal, a filtering process for extracting an analog extraction signal including a signal component corresponding to the analog uplink signal; and converts the analog extraction signal to a digital uplink signal representing a signal level of the analog extraction signal by two or more bits.

### INCORPORATION BY REFERENCE

This application is based upon and claims the benefit of priority from Japanese Patent Application No. 2022-172274, filed on Oct. 27, 2022, the disclosure of which is incorporated herein in its entirety by reference.

### TECHNICAL FIELD

Example embodiments of this disclosure relate to a wireless access system including a centralized control station and an access point connected through an optical network, the centralized control station connected to the access point through the optical network, a signal processing method performed in the wireless access system or the centralized control station, and a recording medium on which a computer program for allowing a computer to execute a signal processing method is recorded.

### BACKGROUND ART

For a wireless access system used in a mobile network, there is known a wireless access system including a centralized control station and an access point connected through an optical network including an optical fiber. In such a wireless communication system, as a technique/technology for transmitting and receiving radio signals between the centralized control station and the access point, the use of a RoF (Radio over Fiber) technique/technology for transmitting and receiving radio signals through the optical network is considered. An example of a method of transmitting and receiving radio signals between the centralized control station and the access point using the RoF technique/technology is described in Non-Patent Literature 1.

Non-Patent Literature 1 further describes that 1-bit transmission using Pulse Width Modulation (PWM) is performed in an uplink. Specifically, in Non-Patent Literature 1, the access point generates a pulse width modulation signal by performing a pulse width modulation process on an uplink signal to be transmitted from the access point to the centralized control station, and transmits the pulse width modulation signal to the centralized control station through an optical network.

### PRIOR ART DOCUMENTS

### Non-Patent Literature

[Non-Patent Literature 1]
Ibrahim Can Sezgin et al., “All-Digital, Radio-Over-Fiber, Communication Link Architecture for Time-Division Duplex Distributed Antenna Systems”, Journal of Lightwave Technology, Vol. 39, No. 9, pp. 2769-2779, May 1, 2021

In the RoF using the pulse width modulation, the pulse width modulation signal is transmitted from the access point to the centralized control station through the optical network. The access point transmits an analog modulation signal as follows. Specifically, the access point generates the analog modulation signal by performing the pulse width modulation process on an analog uplink signal to be transmitted from the access point to the centralized control station. The access point then modulates an optical signal by using the analog modulation signal, thereby to generate an optical uplink signal. The access point then transmits the optical uplink signal through the optical network, thereby to transmit the analog modulation signal through the optical network.

In this case, the centralized control station needs to convert the analog modulation signal received from the access point, to a digital signal. In this instance, the centralized control station may use an AD (Analog to Digital) converter that converts the analog modulation signal to a digital signal representing a signal level of the inputted analog modulation signal by 1 bit, in order to convert the analog modulation signal to the digital signal. In this case, however, the following technical problems arise. Specifically, the AD converter generates the digital signal representing the signal level of the analog modulation signal by 1 bit, by periodically sampling the inputted analog modulation signal with a predetermined sampling period. On the other hand, a rising edge and a falling edge of a pulse of the pulse width modulation signal do not always appear periodically. That is because the rising edge and the falling edges of the pulse of the pulse width modulation signal vary depending on the signal level of the analog uplink signal to be transmitted from the access point to the centralized control station. In this instance, depending on the sampling period, the AD converter is not always capable of generating the digital signal that accurately indicates the signal level of the analog modulation signal. As a result, the centralized control station is not always capable of generating the digital signal that accurately indicates the analog uplink signal.

### SUMMARY

It is an example object of this disclosure to provide a wireless access system, a centralized control station, a signal processing method, and a recording medium that are capable of solving the above-described technical problems. As an example, it is an example object of this disclosure to provide a wireless access system, a centralized control station, a signal processing method, and a recording medium that are capable of properly generating the digital signal that accurately indicates the analog uplink signal to be transmitted from the access point to the centralized control station, from the pulse width modulation signal transmitted from the access point to the centralized control station.

A wireless access system according to an example aspect of this disclosure is a wireless access system including: a centralized control station; and an access point connected to the centralized control station through an optical network, the access point including: a modulation unit that performs a pulse width modulation process on an analog uplink signal to be transmitted from the access point to the centralized control station, thereby to generate an analog modulation signal; and an optical signal conversion unit that converts the analog modulation signal to an optical uplink signal, the centralized control station including: an electrical signal conversion unit that converts the optical uplink signal transmitted from the access point to the centralized control station through the optical network, to an electrical uplink signal; a filter unit that performs, on the electrical uplink signal, a filtering process for extracting an analog extraction signal including a signal component corresponding to the analog uplink signal, from the electrical uplink signal; a digital signal conversion unit that converts the analog extraction signal to a digital uplink signal representing a signal level of the analog extraction signal by two or more bits; and a signal processing unit that performs a predetermined digital signal process on the digital uplink signal.

A centralized control station according to an example aspect of this disclosure is a centralized control station connected to an access point through an optical network, wherein the access point performs a pulse width modulation process on an analog uplink signal to be transmitted from the access point to the centralized control station, thereby to generate an analog modulation signal, and converts the analog modulation signal to an optical uplink signal, and the centralized control station includes: an electrical signal conversion unit that converts the optical uplink signal transmitted from the access point to the centralized control station through the optical network, to an electrical uplink signal; a filter unit that performs, on the electrical uplink signal, a filtering process for extracting an analog extraction signal including a signal component corresponding to the analog uplink signal, from the electrical uplink signal; a digital signal conversion unit that converts the analog extraction signal to a digital uplink signal representing a signal level of the analog extraction signal by two or more bits; and a signal processing unit that performs a predetermined digital signal process on the digital uplink signal.

A signal processing method according to a first example aspect of this disclosure is a signal processing method performed by using a wireless access system including: a centralized control station; and an access point connected to the centralized control station through an optical network, the signal processing method including: performing a pulse width modulation process on an analog uplink signal to be transmitted from the access point to the centralized control station, thereby to generate an analog modulation signal; converting the analog modulation signal to an optical uplink signal; converting the optical uplink signal transmitted from the access point to the centralized control station through the optical network, to an electrical uplink signal; performing, on the electrical uplink signal, a filtering process for extracting an analog extraction signal including a signal component corresponding to the analog uplink signal, from the electrical uplink signal; converting the analog extraction signal to a digital uplink signal representing a signal level of the analog extraction signal by two or more bits; and performing a predetermined digital signal process on the digital uplink signal.

A signal processing method according to a second example aspect of this disclosure is a signal processing method performed by using a centralized control station connected to an access point through an optical network, wherein the access point performs a pulse width modulation process on an analog uplink signal to be transmitted from the access point to the centralized control station, thereby to generate an analog modulation signal, and converts the analog modulation signal to an optical uplink signal, and the signal processing method includes: converting the optical uplink signal transmitted from the access point to the centralized control station through the optical network, to an electrical uplink signal; performing, on the electrical uplink signal, a filtering process for extracting an analog extraction signal including a signal component corresponding to the analog uplink signal, from the electrical uplink signal; converting the analog extraction signal to a digital uplink signal representing a signal level of the analog extraction signal by two or more bits; and performing a predetermined digital signal process on the digital uplink signal.

A recording medium according to a first example aspect of this disclosure is a non-transitory recording medium on which a computer program that allows a computer to execute a signal processing method is recorded, the signal processing method being performed by using a wireless access system including: a centralized control station; and an access point connected to the centralized control station through an optical network, the signal processing method including: performing a pulse width modulation process on an analog uplink signal to be transmitted from the access point to the centralized control station, thereby to generate an analog modulation signal; converting the analog modulation signal to an optical uplink signal; converting the optical uplink signal transmitted from the access point to the centralized control station through the optical network, to an electrical uplink signal; performing, on the electrical uplink signal, a filtering process for extracting an analog extraction signal including a signal component corresponding to the analog uplink signal, from the electrical uplink signal; converting the analog extraction signal to a digital uplink signal representing a signal level of the analog extraction signal by two or more bits; and performing a predetermined digital signal process on the digital uplink signal.

A recording medium according to a second example aspect of this disclosure is a non-transitory recording medium on which a computer program that allows a computer to execute a signal processing method is recorded, the signal processing method being performed by using a centralized control station connected to an access point through an optical network, wherein the access point performs a pulse width modulation process on an analog uplink signal to be transmitted from the access point to the centralized control station, thereby to generate an analog modulation signal, and converts the analog modulation signal to an optical uplink signal, and the signal processing method includes: converting the optical uplink signal transmitted from the access point to the centralized control station through the optical network, to an electrical uplink signal; performing, on the electrical uplink signal, a filtering process for extracting an analog extraction signal including a signal component corresponding to the analog uplink signal, from the electrical uplink signal; converting the analog extraction signal to a digital uplink signal representing a signal level of the analog extraction signal by two or more bits; and performing a predetermined digital signal process on the digital uplink signal.

Effect

According to the wireless access system, the centralized control station, the signal processing method, and the recording medium in the respective example aspects, it is possible to properly generate the digital signal (digital uplink signal) that accurately indicates the analog uplink signal, from the pulse width modulation signal transmitted from the access point to the centralized control station.

### BRIEF DESCRIPTION OF THE DRAWINGS

FIG. 1 is a block diagram illustrating a configuration of a wireless access system in a first example embodiment;

FIG. 2 is a block diagram illustrating respective configurations of a centralized control station and an access point;

FIG. 3 is a diagram illustrating respective waveforms of signals generated in a signal processing method performed by using the wireless access system;

FIG. 4 is a diagram illustrating waveforms of respective signals generated by a signal processing method performed in a comparative example;

FIG. 5 is a block diagram illustrating respective configurations of a centralized control station, an access point, and an optical network in a second example embodiment;

FIG. 6 is a block diagram illustrating respective configurations of a centralized control station, an access point, and an optical network in a third example embodiment

FIG. 7 is a block diagram illustrating respective configurations of a centralized control station and an access point in a fourth example embodiment;

FIG. 8 is a block diagram illustrating respective configurations of a centralized control station and an access point in a fifth example embodiment; and

FIG. 9A and FIG. 9B are block diagrams illustrating other configurations of the wireless access system.

### EXAMPLE EMBODIMENTS

Hereinafter, with reference to the drawings, a wireless access system, a centralized control station, a signal processing method, and a recording medium according to example embodiments will be described, by using a wireless access system SYS to which the wireless access system, the centralized control station, the signal processing method, and the recording medium according to the example embodiments are applied. This disclosure, however, is not limited to the example embodiments described below.

<1> Wireless Access System SYS in First Example Embodiment

First, the wireless access system SYS in the first example embodiment will be described. In the following description, for convenience of explanation, the wireless access system SYS in the first example embodiment is referred to as a wireless access system SYSa.

<1-1> Configuration of Wireless Access System SYSa in First Example Embodiment

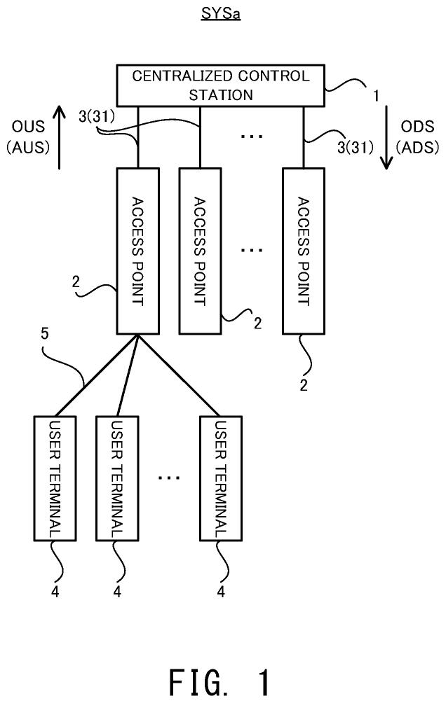

First, a configuration of the wireless access system SYSa in the first example embodiment will be described with reference to FIG. 1. FIG. 1 is a block diagram illustrating the configuration of the wireless access system SYSa according to the first example embodiment.

As illustrated in FIG. 1, the wireless access system SYSa includes a centralized control station 1 and at least one access point 2. Although FIG. 1 illustrates an example in which the wireless access system SYSa includes a plurality of access points 2, the wireless access system SYSa may include a single access point 2.

The centralized control station 1 and each access point 2 are connected through an optical network 3. The optical network 3 is a network including an optical fiber 31. Therefore, the centralized control station 1 generates an optical downlink signal ODS that is an optical signal, from a downlink signal to be transmitted from the centralized control station 1 to each access point 2, and transmits the generated optical downlink signal ODS to each access point 2 through the optical network 3. Similarly, each access point 2 generates an optical uplink signal OUS that is an optical signal, from an uplink signal to be transmitted from each access point 2 to the centralized control station 1, and transmits the generated optical uplink signal OUS to the centralized control station 1 through the optical network 3.

In the first example embodiment, the centralized control station 1 and each access point 2 transmit the signals by using a RoF (Radio over Fiber) technique/technology. In this instance, the centralized control station 1 may modulate (e.g., perform intensity modulation on) the optical signal on the basis of an analog downlink signal ADS to be transmitted from the centralized control station 1 to each access point 2, thereby to generate the modulated optical signal as the optical downlink signal ODS. Similarly, each access point 2 may modulate (e.g., perform intensity modulation on) the optical signal on the basis of an analog uplink signal AUS to be transmitted from each access point 2 to the centralized control station 1, thereby to generate the modulated optical uplink signal OUS.

Each access point 2 is configured to communicate wirelessly with at least one user terminal 4 through a wireless network 5. The wireless network 5 may mean a network that is capable of transmitting information by using a radio wave. An example of the user terminal 4 is a mobile phone. For example, each access point 2 may generate a radio downlink signal on the basis of the analog downlink signal ADS received from the centralized control station 1, and may transmit the radio downlink signal to the user terminal 4 through the wireless network 5. For example, each access point 2 may receive a radio uplink signal RUS from the user terminal 4 through the wireless network 5, may generate the analog uplink signal AUS on the basis of the radio uplink signal RUS, and may transmit the analog uplink signal AUS to the centralized control station 1.

Such a wireless access system SYSa may typically be used for a mobile communication system. For example, the wireless access system SYSa may be used for a fifth-generation mobile communication system that meets IMT-2020 specifications issued by ITU (International Telecommunication Union). For example, the wireless access system SYSa may be used for a mobile communication system referred to as Beyond 5G. In this case, the centralized control station 1 that functions as a so-called base station, and the access point 2 that includes a baseband circuit and an antenna, are geographically and functionally separable. As a result, a plurality of small cells respectively realized by a plurality of access points 2 may be developed or deployed in a conventional macrocell at a high density.

The centralized control station 1 may be referred to as a center unit, an aggregate station, or a baseband unit. The access point 2 may be referred to as a remote unit, an extension station, or a remote wireless unit.

<1-2> Signal Processing Method Performed by Using Wireless Access System SYSa

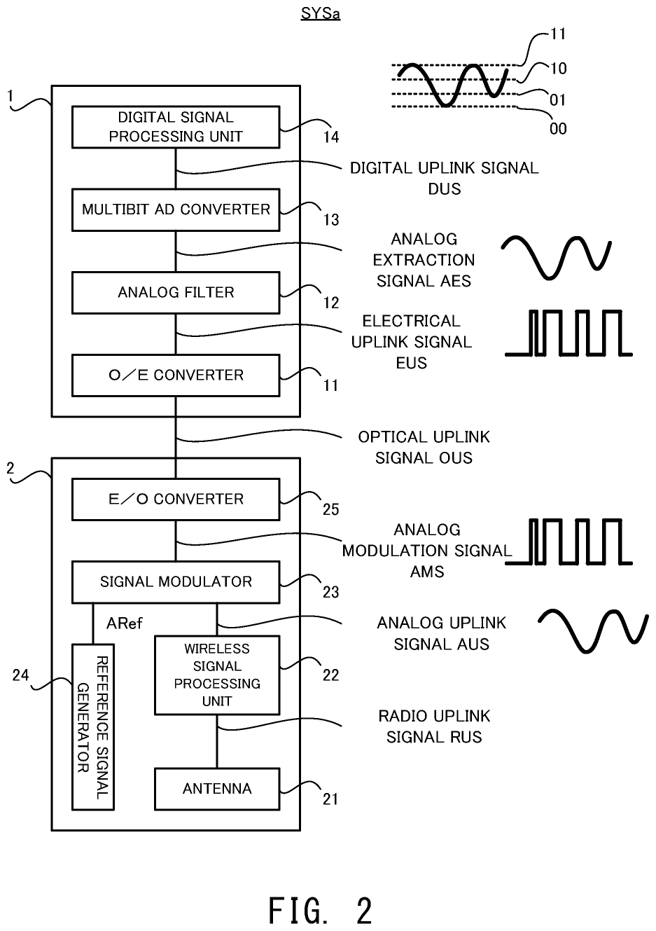

Next, a signal processing method performed by using the wireless access system SYSa will be described. In particular, the signal processing method performed by using the wireless access system SYSa will be described below with reference to FIG. 2 that is a block diagram illustrating the respective configurations of the centralized control station 1 and the access point 2.

Furthermore, for convenience of explanation, the signal processing method performed to transmit the uplink signal will be described below. That is, the signal processing methods performed to transmit the uplink signal from the access point 2 to the centralized control station 1 will be described. As the signal processing method performed to transmit the downlink signal from the centralized control station 1 to the access point 2, an existing signal processing method may be used.

As illustrated in FIG. 2, the centralized control station 1 includes an O/E (Optical to Electrical) converter 11, an analog filter 12, a multibit AD (Analog to Digital) converter 13, and a digital signal processing unit 14. The access point 2 includes an antenna 21, a radio signal processing unit 22, a signal modulator 23, a reference signal generator 24, and an E/O converter 25.

The O/E converter 11 may be referred to as an “electrical signal conversion unit” or an “electrical signal converter”. The analog filter 12 may be referred to as a “filter unit” or a “filter.” The multibit AD converter 13 may be referred to as a “digital signal conversion unit” or a “digital signal converter”. The digital signal processing unit 14 may be referred to as a “signal processing unit”. The radio signal processing unit 22 may be referred to as an “uplink signal generation unit.” The signal modulator 23 may be referred to as a “modulation unit” or a “modulator.” The E/O converter 25 may be referred to as an “optical signal conversion unit” or an “optical signal converter.”

In order to transmit the uplink signal, the antenna 21 of the access point 2 receives a radio uplink signal RUS that is an analog radio signal (RF signal), from the user terminal 4 through the wireless network 5. The radio uplink signal RUS received by the antenna 21 is inputted from the antenna 21 to the radio signal processing unit 22.

The radio signal processing unit 22 performs a predetermined radio signal process on the radio uplink signal RUS, thereby to generate the analog uplink signal AUS that is an analog electrical signal. The radio signal process may include an amplification process of amplifying the radio uplink signal RUS. The radio signal process may include a denoising process of reducing or removing noise components from the radio uplink signal RUS. The denoising process may include a process of removing low-frequency components as the noise components by using a low pass filter (LPF). The radio signal process may include an amplification process of down-converting the radio uplink signal RUS to a signal in a frequency band that is lower than that of the radio uplink signal RUS. As an example, the radio signal process may include an amplification process of down-converting the radio uplink signal RUS to the analog uplink signal AUS of a 2 GHz (gigahertz, the same applies hereinafter) band that is lower than 100 GHz band that is a frequency band of the radio uplink signal RUS. The analog uplink signal AUS generated by the radio signal processing unit 22 is inputted from the radio signal processing unit 22 to the signal modulator 23.

The signal modulator 23 performs a predetermined modulation process on the analog uplink signal AUS, thereby to generate an analog modulation signal AMS that is an analog electrical signal. The first example embodiment describes an example in which the signal modulator 23 performs a pulse width modulation process on the analog uplink signal AUS to generate the analog modulation signal AMS. In this instance, the signal modulator 23 uses an analog reference signal ARef to perform the pulse width modulation process on the analog uplink signal AUS. The analog reference signal ARef is an analog electrical signal generated by the reference signal generator 24. An example of the analog reference signal ARef is a triangular wave signal. The signal modulator 23 compares a signal level of the analog reference signal ARef with that of the analog uplink signal AUS by using a comparator, thereby to generate the analog modulation signal AMS that is an analog pulse signal in which a pulse width varies depending on the signal level of the analog uplink signal AUS. The analog modulation signal AMS generated by the signal modulator 23 is inputted from the signal modulator 23 to the E/O converter 25.

The analog modulation signal AMS is an analog electrical signal, but is a pulse signal. That is why, as illustrated in FIG. 2, the signal level of the analog modulation signal AMS at each time is substantially one of binary levels including a low level and a high level.

The E/O converter 25 converts the analog modulation signal AMS that is an analog electrical signal, to the optical uplink signal OUS that is an optical signal. Specifically, the E/O converter 25 modulates (e.g., performs intensity modulation on) the optical signal on the basis of the analog modulation signal AMS, thereby to generate the modulated optical signal as the optical uplink signal OUS. The optical uplink signal OUS generated by the E/O converter 25 is transmitted from the access point 2 to the centralized control station 1 through the optical network 3.

Here, as described above, since the signal level of the analog modulation signal AMS at each time is one of the binary levels including a low level and a high level, a processing load of the E/O converter 25 is reduced. Therefore, it is possible to reduce a cost of the E/O converter 25.

The centralized control station 1 receives the optical uplink signal OUS transmitted from the access point 2 through the optical network 3. The O/E converter 11 of the centralized control station 1 converts the optical uplink signal OUS that is an optical signal, to an electrical uplink signal EUS that is an analog electrical signal. The electrical uplink signal EUS generated by the O/E converter 11 is inputted from the O/E converter 11 to the analog filter 12. The electrical uplink signal EUS may be referred to as an analog uplink signal.

As illustrated in FIG. 2, the electrical uplink signal EUS is an analog pulse signal in which a pulse width varies depending on the signal level of the analog uplink signal AUS, as in the analog modulation signal AMS. As illustrated in FIG. 2, however, the electrical uplink signal EUS is an analog electrical signal, but is a pulse signal, as in the analog modulation signal AMS. That is why the signal level of the electrical uplink signal EUS at each time is substantially one of the binary levels including a low level and a high level. Consequently, a processing load of the O/E converter 11 is reduced. Therefore, it is possible to reduce a cost of the O/E converter 11.

The analog filter 12 by performs a predetermined filtering process on the electrical uplink signal EUS, thereby to extract an analog extraction signal AES that is an analog electrical signal, from the electrical uplink signal EUS. That is, the filtering process is a process of extracting the analog extraction signal AES from the electrical uplink signal EUS. The analog extraction signal AES extracted by the analog filter 12 is inputted from the analog filter 12 to the multibit AD converter 13.

In the first example embodiment, the filtering process includes a process for extracting, from the electrical uplink signal EUS, the analog extraction signal AES including a signal component corresponding to the analog uplink signal AUS. Thus, as illustrated in FIG. 2, the analog extraction signal AES is an analog electrical signal with a waveform that is generally similar to that of the analog uplink signal AUS.

The analog filter 12 may be a filter that passes a first signal component corresponding to the analog uplink signal AUS of the electrical uplink signal EUS, but cuts a second signal component that is different from the first signal component, of the electrical uplink signal EUS. As an example, the analog filter 12 may be a filter that passes the first signal component included in the frequency band of the analog uplink signal AUS of the electrical uplink signal EUS, but cuts the second signal component included in a frequency band that is different from that of the first signal component, of the electrical uplink signal EUS. Examples of such an analog filter 12 are a low pass filter (LPF), a band pass filter (BPF), and a high pass filter (HPF).

Filtering properties of the analog filter 12 (e.g., frequency characteristics) may be set on the basis of characteristics of the analog uplink signal AUS. As an example, at least one of a cutoff frequency and a passband of the analog filter 12 may be set on the basis of at least one of the frequency band and center frequency of the analog uplink signal AUS.

The multibit AD converter 13 converts the analog extraction signal AES that is an analog electrical signal, to a digital uplink signal DUS that is a digital electrical signal. Specifically, the multibit AD converter 13 samples the analog extraction signal AES at each time when a sampling period specified by a predetermined clock signal elapses, and outputs a digital bit (a bit signal) indicating the signal level of the sampled analog extraction signal AES, as a part of the digital uplink signal DUS. The digital uplink signal DUS generated by the multibit AD converter13 is inputted from the multibit AD converter 13 to the digital signal processing unit 14.

In particular, the multibit AD converter 13 is an AD converter that converts an analog signal to a digital signal representing the signal level of the analog signal by 2 or more bits. For this reason, the multibit AD converter 13 converts the analog extraction signal AES to the digital uplink signal DUS representing the signal level of the analog extraction signal AES by 2 or more bits. That is, the multibit AD converter 13 converts the analog extraction signal AES to the digital uplink signal DUS including a bit signal representing the signal level of the analog extraction signal AES by 2 or more bits.

In the example illustrated in FIG. 2, the multibit AD converter 13 converts the analog extraction signal AES to the digital uplink signal DUS representing the signal level of the analog extraction signal AES by 2 bits. In this instance, the multibit AD converter 13 samples the analog extraction signal AES at each time when the sampling period elapses, and outputs a 2-bit bit signal indicating the signal level of the sampled analog extraction signal AES, as a part of the digital uplink signal DUS. A value of the 2-bit bit signal is set to any of “00”, “01”, “10”, and “11” in accordance with the signal level of the sampled analog extraction signal AES.

The digital signal processing unit 14 performs a predetermined digital signal process on the digital uplink signal DUS. The digital signal process may include a process of separating the digital uplink signal DUS into an I-axis signal component corresponding to an in-phase component (in other words, an in-phase component and an I-axis component) of the radio uplink signal RUS, and a Q-axis signal component corresponding to a quadrature-phase component (in other words, a quadrature-phase component and a Q-axis component) of the radio uplink signal RUS. The digital signal process may include a process of demodulating the digital uplink signal DUS (or the I-axis signal component and the Q-axis signal component).

<1-3> Technical Effect of Wireless Access System SYSa

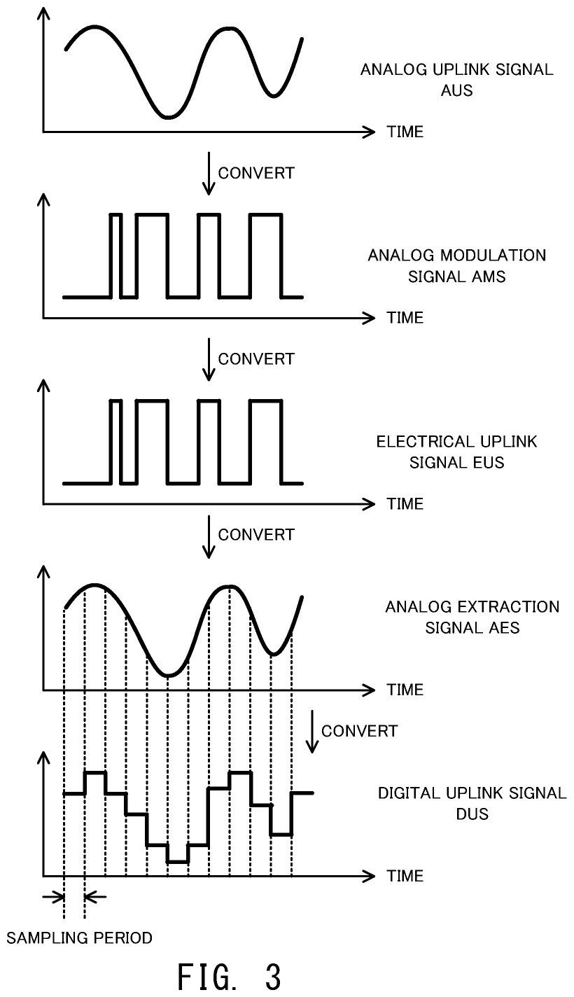

As described above, in the wireless access system SYSa in the first example embodiment, the centralized control station 1 extracts the analog extraction signal AES including the signal component corresponding to the analog uplink signal AUS, from the electrical uplink signal EUS, by using the analog filter 12. Therefore, as illustrated in FIG. 3 that indicates respective waveforms of the e signals generated by the signal processing method, the centralized control station 1 is allowed to extract the analog extraction signal AES with substantially the same waveform as that of the analog uplink signal AUS. The centralized control station 1 then converts the analog extraction signal AES to the digital uplink signal DUS representing the signal level of the analog extraction signal AES by 2 or more bits. Therefore, as illustrated in FIG. 3, the centralized control station 1 is allowed to generate the digital uplink signal DUS that accurately indicates the signal level of the analog uplink signal AUS. Therefore, the centralized control station 1 is allowed to properly generate the digital uplink signal DUS that accurately indicates the signal level of the analog uplink signal AUS, even when the access point 2 transmits the analog modulation signal AMS generated by the pulse width modulation process. That is, the wireless access system SYSa is configured to generate the digital uplink signal DUS that is the same as the digital uplink signal DUS generated when the analog uplink signal AUS, instead of the analog modulation signal AMS, is transmitted to the centralized control station 1, while reducing the costs of the E/O converter 25 and the O/E converter 11 by transmitting the analog modulation signal AMS generated by the pulse width modulation process.

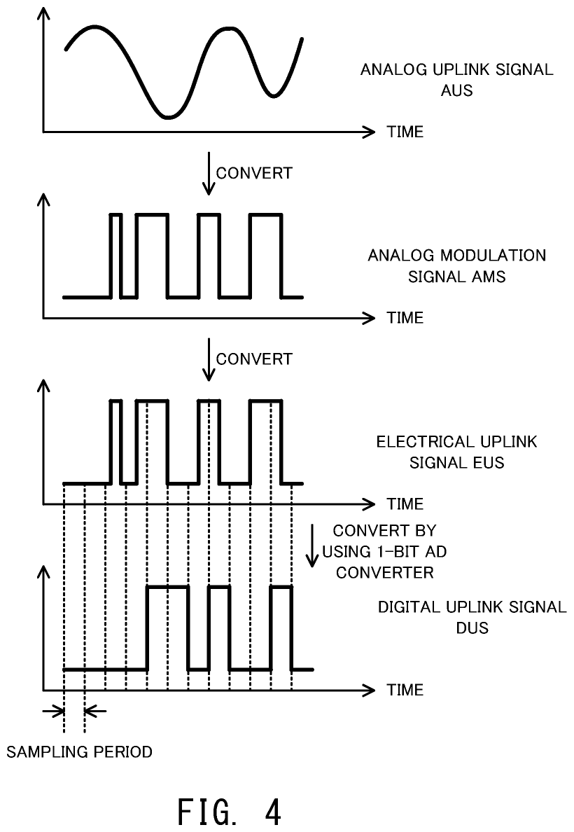

As a comparative example, the centralized control station 1 may also generate the digital uplink signal DUS from the electrical uplink signal EUS, by using a 1-bit AD converter. The 1-bit AD converter is an AD converter that converts the analog signal to a digital signal representing the signal level of the analog signal by 1 bit. In this instance, as illustrated in FIG. 4 that illustrates the digital uplink signal DUS generated by using the 1-bit AD converter, the 1-bit AD converter generates the digital uplink signal DUS representing the signal level of the electrical uplink signal EUS by 1 bit, by periodically sampling the electrical uplink signal EUS with a predetermined sampling period. On the other hand, a rising edge and a falling edge of a pulse of the electrical uplink signal EUS do not always appear periodically. That is, the signal level of the electrical uplink signal EUS does not always change in timing synchronized with the sampling period. That is because the rising edge and the falling edge of the pulse of the electrical uplink signal EUS vary depending on the signal level of the analog uplink signal AUS. In this instance, depending on the sampling period, as illustrated in FIG. 4, the 1-bit AD converter is not always capable of generating the digital uplink signal DUS that accurately indicates the signal level of the electrical uplink signal EUS (i.e., the signal level of the analog modulation signal AMS). Consequently, the centralized control station 1 has such a technical problem that it is not always capable of generating the digital uplink signal DUS that accurately indicates the analog uplink signal AUS. The wireless access system SYSa in the first example embodiment, however, is allowed to solve such a technical problem, by using the analog filter 12 and the multibit AD converter 13.

Even in the comparative example, it is also possible to generate the digital uplink signal DUS that accurately indicates the signal level of the electrical uplink signal EUS (i.e., the signal level of the analog modulation signal AMS), by shortening the sampling period of the 1-bit AD converter (i.e., by increasing a sampling rate). As an example, however, in 5G or the like in which the radio uplink signal RUS of a 100 GHz band is used, it is necessary to set the sampling period of the 1-bit AD converter to a very short period that allows several trillion times of sampling per second. It is necessary to set the sampling rate of the 1-bit AD converter to a very high rate that allows several trillion times of sampling per second. Therefore, there is a limit to measures to shorten the sampling period of the 1-bit AD converter. Therefore, the wireless access system SYSa in the first example embodiment is also beneficial in that it is not necessary to excessively shorten the sampling period of the multibit AD converter 13. That is, the wireless access system SYSa in the first example embodiment is beneficial in that performance constraints (typically, constraints on the sampling period) required for the multibit AD converter 13 to generate a highly accurate digital uplink signal DUS are mitigated.

<2> Wireless Access System SYS in Second Example Embodiment

Next, the wireless access system SYS in a second example embodiment will be described. In the following description, for convenience of explanation, the wireless access system SYS in the second example embodiment is referred to as a wireless access system SYSb. The wireless access system SYSb in the second example embodiment is different from the wireless access system SYSa in the first example embodiment in that it includes a centralized control station 1b, at least one access point 2b, and an optical network 3b, instead of the centralized control station 1, the at least one access point 2, and the optical network 3. Other features of the wireless access system SYSb may be the same as those of the wireless access system SYSa.

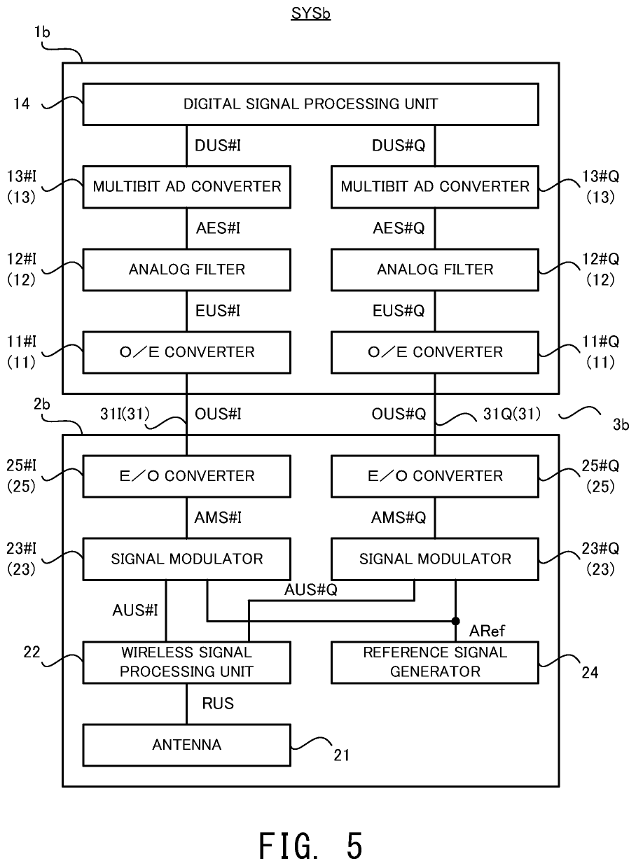

Therefore, in the following, with reference to FIG. 5, the centralized control station 1b in the second example embodiment, the at least one access point 2b, and the optical network 3b will be described. FIG. 5 is a block diagram illustrating respective configurations of the centralized control station 1b, the access point 2b, and the optical network 3b in the second example embodiment. In the following description, the already described components carry the same reference numerals, and a detailed description thereof will be omitted.

As illustrated in FIG. 5, the centralized control station 1b is different from the centralized control station 1 in that it includes two O/E converters 11, two analog filters 12, and two multibit AD converters 13. Specifically, the centralized control station 1b includes O/E converters 11 #I and 11 #Q, analog filters 12 #I and 12 #Q, and multibit AD converters 13 #I and 13 #Q. Other features of the centralized control station 1b may be the same as those of the centralized control station 1.

Furthermore, the access point 2b is different from the access point 2 in that it includes two signal modulators 23 and two E/O converters 25. Specifically, the access point 2b includes signal modulators 23 #I and 23 #Q, and E/O converters 25 #I and 25 #Q. Other features of the access point 2b may be the same as those of the access point 2.

Furthermore, the optical network 3b is different from the optical network 3 in that it includes two optical fibers 31. Specifically, the optical network 3b includes optical fibers 31 #I and 31 #Q. Other features of the optical network 3b may be the same as those of the optical network 3.

Next, a signal processing method performed by using the wireless access system SYSb in the second example embodiment will be described.

Even in the second example embodiment, as in the first example embodiment, the antenna 21 of the access point 2b receives the radio uplink signal RUS from the user terminal 4 through the wireless network 5. Thereafter, the radio signal processing unit 22 performs a predetermined radio signal process on the radio uplink signal RUS, thereby to generate the analog uplink signal AUS. Especially in the second example embodiment, the radio signal process includes an IQ separation process of generating, from the radio uplink signal RUS, the analog uplink signal AUS corresponding to the in-phase component of the radio uplink signal RUS (specifically, an analog uplink signal AUS #I), and the analog uplink signal AUS corresponding to the quadrature-phase component of the radio uplink signal RUS (specifically, an analog uplink signal AUS #Q). The analog uplink signal AUS #I generated by the radio signal processing unit 22 is inputted from the radio signal processing unit 22 to the signal modulator 23 #I. The analog uplink signal AUS #Q generated by the radio signal processing unit 22 is inputted from the radio signal processing unit 22 to the signal modulator 23 #Q.

The signal modulator 23 #I performs a predetermined modulation process on the analog uplink signal AUS #I, thereby to generate the analog modulation signal AMS (specifically, an analog modulation signal AMS #I). The signal modulator 23 #Q performs the predetermined modulation process on the analog uplink signal AUS #I, thereby to generate the analog modulation signal AMS (specifically, an analog modulation signal AMS #Q).

The E/O converter 25 #I converts the analog modulation signal AMS #I to the optical uplink signal OUS (specifically, an optical uplink signal OUS #I). The E/O converter 25 #Q converts the analog modulation signal AMS #Q to the optical uplink signal OUS (specifically, an optical uplink signal OUS #Q).

The optical uplink signal OUS #I generated by the E/O converter 25 #I is transmitted from the access point 2b to the centralized control station 1b through the optical network 3b (especially, the optical fiber 31 #I). The optical uplink signal OUS #Q generated by the E/O converter 25 #Q is transmitted from the access point 2b to the centralized control station 1b through the optical network 3b (especially, the optical fiber 31 #Q).

When E/O converters that allow wavelength multiplex are used as the E/O converters #I and 25 #Q, the access point 2b may transmit the optical uplink signals OUS #I and OUS #Q to the centralized control station 1b through the same optical fiber 31. An example of the E/O converter that allows wavelength multiplex is QSFP (Quad Small Form-factor Pluggable).

The O/E converter 11 #I converts the optical uplink signal OUS #I to the electrical uplink signal EUS (specifically, an electrical uplink signal EUS #I). The O/E converter 11 #Q converts the optical uplink signal OUS #Q to the electrical uplink signal EUS (specifically, an electrical uplink signal EUS #Q).

The analog filter 12 #I performs a predetermined filtering process on the electrical uplink signal EUS #I, thereby to extract the analog extraction signal AES (specifically, an analog extraction signal AES #I) from the electrical uplink signal EUS #I. The analog extraction signal AES #I is a signal including a signal component corresponding to the analog uplink signal AUS #I. The analog filter 12 #Q performs the predetermined filtering process on the electrical uplink signal EUS #Q, thereby to extract the analog extraction signal AES (specifically, an analog extraction signal AES #Q) from the electrical uplink signal EUS #Q. The analog extraction signal AES #Q is a signal including a signal component corresponding to the analog uplink signal AUS #Q.

The multibit AD converter 13 #I converts the analog extraction signal AES #I to the digital uplink signal DUS (specifically, a digital uplink signal DUS #I). The multibit AD converter 13 #Q converts the analog extraction signal AES #Q to the digital uplink signal DUS (specifically, a digital uplink signal DUS #Q).

The digital signal processing unit 14 performs a predetermined digital signal process on the digital uplink signals DUS #I and DUS #Q.

As described above, in the second example embodiment, the wireless access system SYSb is configured to perform signal processing using two signals generated by the IQ separation process (specifically, the analog uplink signals AUS #I and AUS #Q). Here, the center frequencies of the analog uplink signals AUS #I and AUS #Q generated by the IQ separation process are typically lower than the center frequency of the analog uplink signal AUS in the first example embodiment generated without using the IQ separation process. In some cases, the center-frequencies of the analog uplink signals AUS #I and AUS #Q generated by the IQ separation process may be set to 0 Hz. Consequently, in the second example embodiment, the performance constraints (typically, the constraints on the sampling period) required for the multibit AD converter 13 to generate a highly accurate digital uplink signal DUS are further mitigated, as compared with those in the first example embodiment. Furthermore, with the mitigation of the performance constraints required for the multibit AD converter 13, it is possible to further reduce the costs of the E/O converter 25 provided in the access point 2b and the O/E converter 11 provided in the centralized control station 1b.

<3> Wireless Access System SYS in Third Example Embodiment

Next, the wireless access system SYS in a third example embodiment will be described. In the following description, for convenience of explanation, the wireless access system SYS in the third example embodiment is referred to as a wireless access system SYSc. The wireless access system SYSc in the third example embodiment s different from the wireless access system SYSa in the first example embodiment in that it includes a centralized control station 1c, at least one access point 2c, and an optical network 3c, instead of the centralized control station 1, the at least one access point 2, and the optical network 3. Other features of the wireless access system SYSc may be the same as those of the wireless access system SYSa.

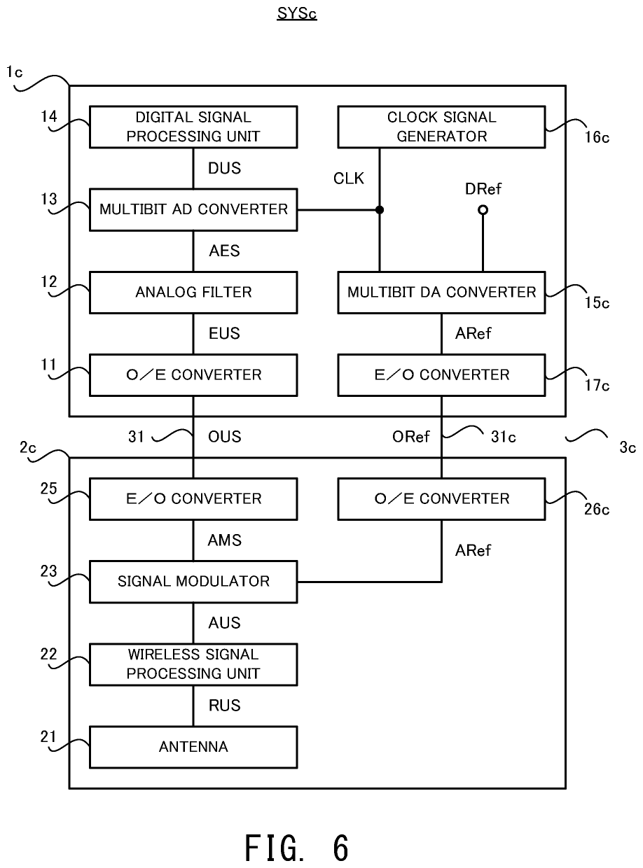

Therefore, in the following, with reference to FIG. 6, the centralized control station 1c in the third example embodiment, the at least one access point 2c, and the optical network 3c will be described. FIG. 6 is a block diagram illustrating respective configurations of the centralized control station 1c, the access point 2c, and the optical network 3c in the third example embodiment.

As illustrated in FIG. 6, the centralized control station 1c is different from the centralized control station 1 in that it includes a multibit DA (Digital to Analog) converter 15c, a clock signal generator 16c, and a E/O converter 17c. Other features of the centralized control station 1c may be the same as those of the centralized control station 1. The multibit DA converter 15c may be referred to as an analog signal conversion unit.

Furthermore, the access point 2c is different from the access point 2 in that it may not need to include the reference signal generator 24. In addition, the access point 2c is different from the access point 2 in that it includes an O/E converter 26c. Other features of the access point 2c may be the same as those of the access point 2.

Furthermore, the optical network 3c is different from the optical network 3 in that it further includes an optical fiber 31c. Other features of the optical network 3c may be the same as those of the optical network 3.

Next, a signal processing method performed by using the wireless access system SYSc in the third example embodiment will be described. In the following description, a difference between the signal processing method performed by using the wireless access system SYSc in the third example embodiment and the signal processing method performed by using the wireless access system SYSa in the first example embodiment will be mainly described. Therefore, unless otherwise described, the wireless access system SYSc may perform the same signal processing method as the signal processing method performed by using the wireless access system SYSa in the first example embodiment.

The signal processing method performed by using the wireless access system SYSc in the third example embodiment is different from the signal processing method performed by using the wireless access system SYSa in the first example embodiment in that the multibit AD converter 13 of the centralized control station 1c converts the analog extraction signal AES to the digital uplink signal DUK in synchronization with a predetermined clock signal CLK generated by the clock signal generator 16c. For example, the multibit AD converter 13 samples the analog extraction signal AES at each time when the sampling period specified by the clock signal CLK elapses, and outputs the bit signal indicating the signal level of the sampled analog extraction signal AES, as a part of the digital uplink signal DUS.

Furthermore, the signal processing method performed by using the wireless access system SYSc in the third example embodiment is different from the signal processing method performed by using the wireless access system SYSa in the first example embodiment in that the multibit DA converter 15c converts a digital reference signal DRef that is a digital electrical signal, to the analog reference signal Aref that is an analog electrical signal. In particular, the multibit DA converter 15c converts the digital reference signal DRef to the analog reference signal ARef, in synchronization with the predetermined clock signal CLK generated by the clock signal generator 16c. That is, the multibit DA converter 15c converts the digital reference signal DRef to the analog reference signal ARef, in synchronization with the clock signal CLK used by the multibit AD converter 13 to generate the digital uplink signal DUS.

The analog reference signal ARef generated by the multibit DA converter 15c is inputted from the multibit DA converter 15c to the E/O converter 17c. The E/O converter 17c converts the analog reference signal Aref that is an analog electrical signal, to an optical reference signal ORef that is an optical signal. Specifically, the E/O converter 17c modulates (e.g., performs intensity modulation on) the optical signal on the basis of the analog reference signal ARef, thereby to generate the modulated optical signal as the optical reference signal ORef. The optical reference signal ORef generated by the E/O converter 17c is transmitted from the centralized control station 1c to the access point 2c through the optical network 3c (especially, the optical fiber 31c).

The O/E converter 26c converts the optical reference signal ORef that is an optical signal, to the analog reference signal Aref that is an analog electrical signal. That is, the O/E converter 26c restores, from the optical reference signal ORef, the analog reference signal ARef converted to the optical reference signal ORef in the E/O converter 17c.

The analog reference signal ARef generated by the O/E converter 26c is inputted to the signal modulator 23. The signal modulator 23 by performs a predetermined modulation process on the analog uplink signal AUS by using the analog reference signal ARef generated by the O/E converter 26c, thereby to generate the analog modulation signal AMS.

As described above, in the third example embodiment, the multibit AD converter 13 that generates the digital uplink signal DUS, and the multibit DA converter 15c that generates the analog reference signal ARef operate in timing based on the same clock signal CLK. Furthermore, since the analog reference signal ARef is generated in synchronization with the clock signal CLK, it can be said that the signal modulator 23 that generates the analog modulation signal AMS by using the analog reference signal Aref, also substantially operates in the timing based on the clock signal CLK. Therefore, the multibit AD converter 13 is allowed to generate the analog uplink signal AUS in synchronization with timing when the signal modulator 23 generates the analog uplink signal AUS. Therefore, it is possible to reduce an effect of jitter of the digital uplink signal DUS.

The wireless access system SYSb in the second example embodiment may include the components peculiar to the wireless access system SYSc in the third example embodiment. The components peculiar to the wireless access system SYSc in the third example embodiment may include at least one of a component associated with the process using the clock signal CLK and a component associated with the generation of the analog reference signal ARef.

<4> Wireless Access System SYS in Fourth Example Embodiment

Next, the wireless access system SYS in a fourth example embodiment will be described. In the following description, for convenience of explanation, the wireless access system SYS in the fourth example embodiment is referred to as a wireless access system SYSd. The wireless access system SYSd in the fourth example embodiment is different from the wireless access system SYSc in the third example embodiment in that it includes a centralized control station 1d and an access point 2d, instead of the centralized control station 1c and the access point 2c. Other features of the wireless access system SYSd may be the same as those of the wireless access system SYSc.

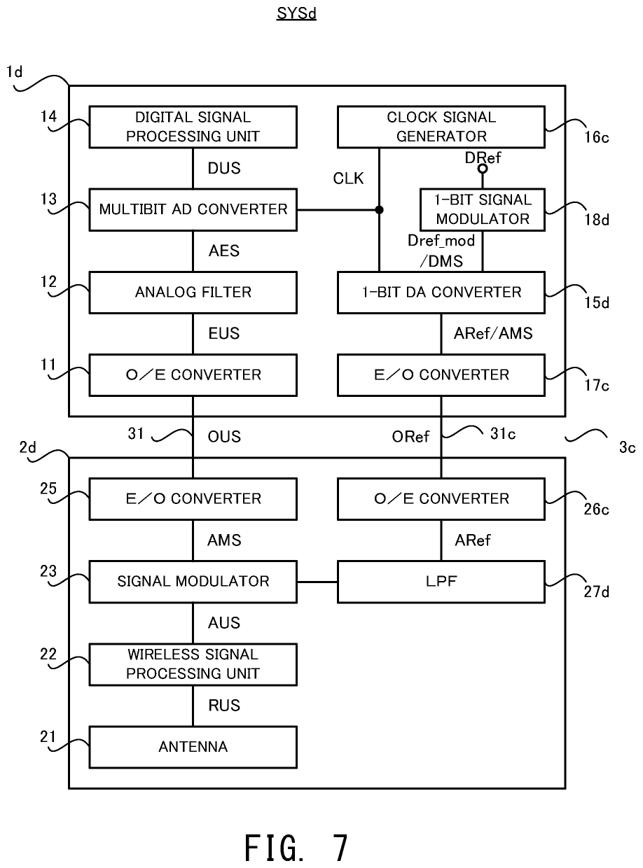

Therefore, in the following, with reference to FIG. 7, the centralized control station 1d and the access point 2d in the fourth example embodiment will be described. FIG. 7 is a block diagram illustrating respective configurations of the centralized control station 1d and the access point 2d in the fourth example embodiment.

As illustrated in FIG. 7, the centralized control station 1d is different from the centralized control station 1c in that it includes a 1-bit DA converter 15d, instead of the multibit DA converter 15c. Furthermore, the centralized control station 1d is different from the centralized control station 1c in that it includes a 1-bit signal modulator 18d. Other features of the centralized control station 1d may be the same as those of the centralized control station 1c. Each of the 1-bit DA converter 15d and the 1-bit signal modulator 18d may be referred to as an analog signal conversion unit.

Additionally, the access point 2d is different from the access point 2c in that it includes a low pass filter (LPF) 27d. Other features of the access point 2d may be the same as those of the access point 2c.

Next, a signal processing method performed by using the wireless access system SYSd in the fourth example embodiment will be described. In the following description, a difference between the signal processing method performed by using the wireless access system SYSd in the fourth example embodiment and the signal processing method performed by using the wireless access system SYSc in the third example embodiment will be mainly described. Therefore, unless otherwise described, the wireless access system SYSd may perform the same signal processing method as the signal processing method performed by using the wireless access system SYSc in the third example embodiment.

The signal processing method performed by using the wireless access system SYSd in the fourth example embodiment is different from the signal processing method performed by using the wireless access system SYSc in the third example embodiment, in a direction in which the centralized control station 1d generates the analog reference signal ARef from the digital reference signal DRef. Specifically, the 1-bit signal modulator 18d of the centralized control station 1d performs a predetermined digital modulation process on the digital reference signal DRef, thereby to generate a digital modulation signal DRef_mod that is a digital signal that allows 1-bit signal processing. An example of the digital modulation process that is capable of generating the digital signal that allows the 1-bit signal processing, is at least one of the pulse width modulation process and a ΔΣ modulation process. Then, the 1-bit DA converter 15d converts the digital modulation signal DRef_mod that is a digital electrical signal, to the analog reference signal Aref that is an analog electrical signal. Here, as described above, since the digital modulation signal DRef_mod is the digital signal that allows the 1-bit signal processing, the signal level of the analog reference signal ARef is substantially one of the binary levels including a low level and a high level. Consequently, processing loads of the E/O converter 17c and the O/E converter 26c that transmit the analog reference signal ARef are reduced. Therefore, it is possible to reduce costs of the E/O converter 17c and the O/E converter 26c.

The analog reference signal ARef generated by the 1-bit DA converter 15d is transmitted, as the optical reference signal ORef, from the centralized control station 1d to the access point 2d. Consequently, in the fourth example embodiment, as in the third example embodiment, the signal modulator 23 performs a predetermined modulation process using the analog reference signal ARef generated by the O/E converter 26c, on the analog uplink signal AUS, thereby to generate the analog modulation signal AMS. In the fourth example embodiment, however, the analog reference signal ARef generated by the O/E converter 26c is inputted to the signal modulator 23 after passing through the low pass filter 27d. Consequently, the signal modulator 23 may use the analog reference signal ARef from which a high-frequency noise component is removed by the low pass filter 27d, to perform the predetermined modulation process. That is, the signal modulator 23 may use the analog reference signal ARef with an appropriate waveform (e.g., the analog reference signal ARef that is a triangular wave signal) to perform the predetermined modulation process.

As described above, the wireless access system SYSd in the fourth example embodiment is allowed to reduce the costs of the E/O converter 17c and the O/E converter 26c, while enjoying benefits of the wireless access system SYSc in the third example embodiment.

<5> Wireless Access System SYS in Fifth Example Embodiment

Next, the wireless access system SYS in a fifth example embodiment will be described. In the following description, for convenience of explanation, the wireless access system SYS in the fifth example embodiment is referred to as a wireless access system SYSe. The wireless access system SYSd in the fifth example embodiment is different from the wireless access system SYSd in the fourth example embodiment in that it includes a centralized control station 1e and an access point 2, instead of the centralized control station 1d and the access point 2d. Other features of the wireless access system SYSe may be the same as those of the wireless access system SYSd.

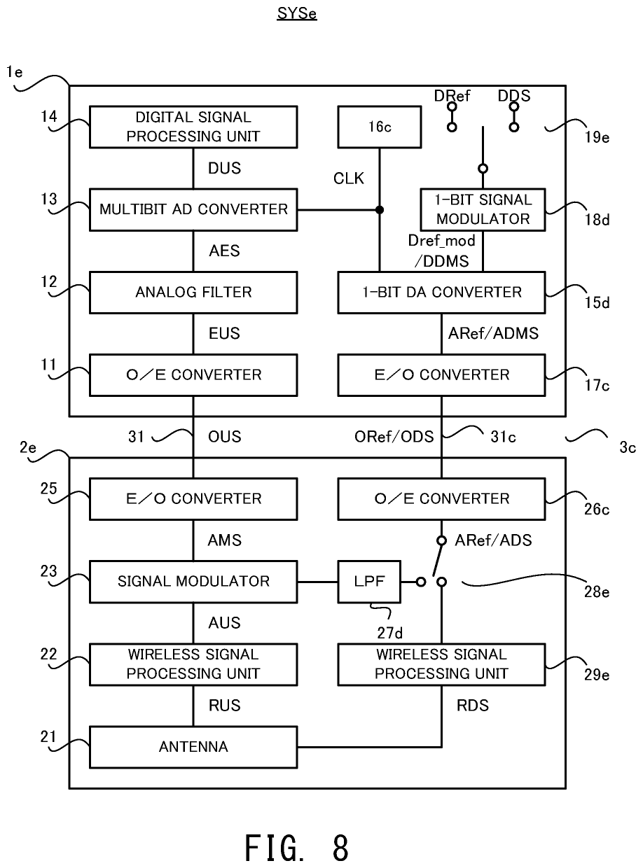

Therefore, in the following, the centralized control station 1e and the access point 2e in the fifth example embodiment will be described with reference to FIG. 8. FIG. 8 is a block diagram illustrating respective configurations of the centralized control station 1e and the access point 2e in the fifth example embodiment.

As illustrated in FIG. 8, the centralized control station 1e is different from the centralized control station 1e in that it includes a switch 19e. Other features of the centralized control station 1e may be the same as those of the centralized control station 1d. In addition, the access point 2e is different from the access point 2d in that it includes a switch 28e and a radio signal processing unit 29e. Other features of the access point 2e may be the same as those of the access point 2d.

Next, a signal processing method performed by using the wireless access system SYSe in the fifth example embodiment will be described. In the following description, a difference between the signal processing method performed by using the wireless access system SYSd in the fifth example embodiment and the signal processing method performed by using the wireless access system SYSd in the fourth example embodiment will be mainly described. Therefore, unless otherwise described, the wireless access system SYSe may perform the same signal processing method as the signal processing method performed by using the wireless access system SYSd in the fourth example embodiment.

The signal processing method performed by using the wireless access system SYSe in the fifth example embodiment is different from the signal processing method performed by using the wireless access system SYSd in the fourth example embodiment, in that a signal inputted to the 1-bit signal modulator 18d is switched by the switch 19e in the centralized control station 1e. Specifically, the switch 19e switches the signal inputted to the 1-bit signal modulator 18d between the digital reference signal DRef and a digital downlink signal DDS that is a digital electrical signal to be transmitted from the centralized control station 1e to the access point 2e.

The switch 19e may switch the signal inputted to the 1-bit signal modulator 18d such that the digital reference signal DRef is inputted to the 1-bit signal modulator 18d in timing when the centralized control station 1e does not transmit the downlink signal (the digital downlink signal DDS) to the access point 2e. On the other hand, the switch 19e may switch the signal inputted to the 1-bit signal modulator 18d such that the digital downlink signal DDS is inputted to the 1-bit signal modulator 18d in timing when the centralized control station 1e transmits the downlink signal (the digital downlink signal DDS) to the access point 2e.

Furthermore, the signal processing method performed by using the wireless access system SYSe in the fifth example embodiment is different from the signal processing method performed by using the wireless access system SYSd in the fourth example embodiment, in that an output target of the signal outputted from the O/E converter 26c is switched by the switch 28e in the access point 2e. Specifically, the switch 28e switches the output target of the signal outputted from the O/E converter 26c between the low pass filter 27d and the radio signal processing unit 29e.

When the digital reference signal DRef is inputted to the 1-bit signal modulator 18d, as described in the fourth example embodiment, the 1-bit signal modulator 18d generates the digital modulation signal DRef_mod, the 1-bit DA converter 15d generates the analog reference signal ARef, and the E/O converter 17c transmits the optical reference signal ORef. Furthermore, in this case, the analog reference signal ARef generated by the O/E converter 26c that receives the optical reference signal ORef is inputted to the signal modulator 23 through the low pass filter 27d.

On the other hand, when the digital downlink signal DDS is inputted to the 1-bit signal modulator 18d, the 1-bit signal modulator 18d performs a predetermined digital modulation process on the digital downlink signal DDS, thereby to generate a digital downlink modulation signal DDMS that is a digital signal that allows the 1-bit signal processing. Then, the 1-bit DA converter 15d converts the digital downlink modulation signal DDMS that is a digital electrical signal, to an analog downlink modulation signal ADMS that is an analog electrical signal. Here, since the digital downlink modulation signal DDMS is the digital signal that allows the 1-bit signal processing, the signal level of the analog downlink modulation signal ADMS is substantially one of the binary levels including a low level and a high level. Consequently, the processing loads of the E/O converter 17c and the O/E converter 26c that transmit the analog downlink modulation signal ADMS are reduced. Therefore, it is possible to reduce the costs of the E/O converter 17c and the O/E converter 26c.

The analog downlink modulation signal ADMS generated by the 1-bit DA converter 15d is transmitted, as the optical downlink signal ODS, from the centralized control station 1e to the access point 2e. The O/E converter 26c converts the optical downlink signal ODS that is an optical signal, to the analog downlink signal ADS that is an analog electrical signal. The analog downlink signal ADS generated by the O/E converter 26c is inputted to the radio signal processing unit 29e. The radio signal processing unit 29e performs a predetermined radio signal process on the analog downlink signal ADS, thereby to generate a radio downlink signal RDS. The radio downlink signal RDS generated by the radio signal processing unit 29e is transmitted to the user terminal 4 through the antenna 21.

As described above, the wireless access system SYSe in the fifth example embodiment is configured to transmit the analog reference signal ARef from the centralized control station 1e to the access point 2e, by using a transmission link (a downlink) for transmitting the downlink signal. Therefore, the wireless access system SYSe may not need to include a dedicated transmission link for transmitting the analog reference signal Aref, and it is thus possible to reduce a cost of the wireless access system SYSe.

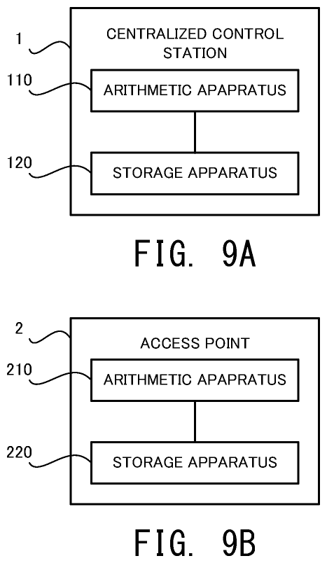

As illustrated in FIG. 9, the wireless access system SYSc in the third example embodiment may also include the components peculiar to the wireless access system SYSe in the fifth example embodiment. The components peculiar to the wireless access system SYSe in the fifth example embodiment may include a component for transmitting the analog reference signal ARef from the centralized control station 1e to the access point 2e by using the transmission link (the downlink) for transmitting the downlink signal.

<6> Modified Example

The above describes an example in which each of the analog filter 12, the multibit AD converter 13, and the digital signal processing unit 14 provided in the centralized control station 1 is hardware; however, a process performed by at least one of the analog filter 12, the multibit AD converter 13, and the digital signal processing unit 14 may be realized by software. For example, as illustrated in FIG. 9A, the centralized control station 1 may include an arithmetic apparatus 110 such as a CPU (Central Processing Unit, and a storage apparatus 120 such as a memory. The arithmetic apparatus 110 may execute a computer program recorded in the storage apparatus 120. Consequently, a logical processing block that performs the process performed by at least one of the analog filter 12, the multibit AD converter 13, and the digital signal processing unit 14 may be realized or implemented in the arithmetic apparatus 110.

The above describes an example in which each of the radio signal processing unit 22, the signal modulator 23, and the reference signal generator 24 provided in the access point 2 is hardware; however, a process performed by at least one of the radio signal processing unit 22, the signal modulator 23, and the reference signal generator 24 may be realized by software. For example, as illustrated in FIG. 9B, the access point 2 may include an arithmetic apparatus 210 such as a CPU (Central Processing Unit), and a storage apparatus 220 such as a memory. The arithmetic apparatus 210 may execute a computer program recorded in the storage apparatus 220. Consequently, a logical processing block that performs the process performed by at least one of the radio signal processing unit 22, the signal modulator 23, and the reference signal generator 24 may be realized or implemented in the arithmetic apparatus 210.

<7> Supplementary Notes

With respect to the example embodiment described above, the following Supplementary Notes are further disclosed.

[Supplementary Note 1]

A wireless access system comprising:
a centralized control station; and
an access point connected to the centralized control station through an optical network,
the access point including:
a modulator that performs a pulse width modulation process on an analog uplink signal to be transmitted from the access point to the centralized control station, thereby to generate an analog modulation signal; and
an optical signal convertor that converts the analog modulation signal to an optical uplink signal,
the centralized control station including:
an electrical signal convertor that converts the optical uplink signal transmitted from the access point to the centralized control station through the optical network, to an electrical uplink signal;
a filter that performs, on the electrical uplink signal, a filtering process for extracting an analog extraction signal including a signal component corresponding to the analog uplink signal, from the electrical uplink signal;
a digital signal convertor that converts the analog extraction signal to a digital uplink signal representing a signal level of the analog extraction signal by two or more bits; and
a signal processor that performs a predetermined digital signal process on the digital uplink signal.

[Supplementary Note 2]

The wireless access system according to the Supplementary Note 1, wherein the access point further includes:
an antenna that receives a radio uplink signal; and
an uplink signal generator that generates, from the radio uplink signal received by using
the antenna, each of a first analog uplink signal corresponding to an in-phase component of the radio uplink signal and a second analog uplink signal corresponding to a quadrature-phase component of the radio uplink signal,
the modulator includes: a first modulator that performs the pulse width modulation process on the first analog uplink signal, thereby to generate a first analog modulation signal; and a second modulator that performs the pulse width modulation process on the second analog uplink signal, thereby to generate a second analog modulation signal,
the optical signal convertor includes: a first optical signal converter that converts a first pulse width modulation signal to a first optical uplink signal; and a second optical signal converter that converts a second pulse width modulation signal to a second optical uplink signal,
the electrical signal convertor includes: a first electrical signal converter that converts the first optical uplink signal transmitted from the access point to the centralized control station through a first optical fiber included in the optical network, to a first electrical uplink signal; and a second electrical signal converter that converts the second optical uplink signal transmitted from the access point to the centralized control station through a second optical fiber included in the optical network, to a second electrical uplink signal,
the filter includes: a first filter that performs, on the first electrical uplink signal, a filtering process for extracting a first analog extraction signal including a signal component corresponding to the first analog uplink signal, from the first electrical uplink signal; and a second filter that performs, on the second electrical uplink signal, a filtering process for extracting a second analog extraction signal including a signal component corresponding to the second analog uplink signal, from the second electrical uplink signal,
the digital signal convertor includes: a first digital signal converter that converts the first analog extraction signal to a first digital uplink signal representing a signal level of the first analog extraction signal by two or more bits; and a second digital signal converter that converts the second analog extraction signal to a second digital uplink signal representing a signal level of the second analog extraction signal by two or more bits, and
the signal processor performs the predetermined digital signal process on the first and second digital uplink signals.

[Supplementary Note 3]

The wireless access system according to the Supplementary Note 1, wherein
the centralized control station further includes an analog signal convertor that converts an inputted digital reference signal to an analog reference signal, in synchronization with a predetermined clock signal,
the modulator obtains the analog reference signal from the centralized control station through the optical network, and performs the pulse width modulation process while using the analog reference signal as a comparison signal to be compared with the analog uplink signal, thereby to generate a pulse width modulation signal, and
the digital signal convertor converts the analog extraction signal to the digital uplink signal in synchronization with the clock signal.

[Supplementary Note 4]

The wireless access system according to the Supplementary Note 3, wherein the analog signal convertor converts the digital reference signal to the analog reference signal whose signal level varies discretely between two different levels, in synchronization with the clock signal.

[Supplementary Note 5]

The wireless access system according to the Supplementary Note 3 or 4, wherein
in a first period in which the optical uplink signal is transmitted from the access point to the centralized control station, the analog signal convertor converts the digital reference signal to the analog reference signal, and the modulator performs the pulse width modulation process while using the analog reference signal as the comparison signal, thereby to generate the pulse width modulation signal, and
in a second period that is different from the first time period, the analog signal convertor converts a digital downlink signal to be transmitted from the centralized control station to the access point, to an analog downlink signal, and the modulator does not generate the pulse width modulation signal.

[Supplementary Note 6]

A centralized control station connected to an access point through an optical network, wherein
the access point performs a pulse width modulation process on an analog uplink signal to be transmitted from the access point to the centralized control station, thereby to generate an analog modulation signal, and converts the analog modulation signal to an optical uplink signal, and the centralized control station comprises:
an electrical signal convertor that converts the optical uplink signal transmitted from the
access point to the centralized control station through the optical network, to an electrical uplink signal;
a filter that performs, on the electrical uplink signal, a filtering process for extracting an analog extraction signal including a signal component corresponding to the analog uplink signal, from the electrical uplink signal;
a digital signal convertor that converts the analog extraction signal to a digital uplink signal representing a signal level of the analog extraction signal by two or more bits; and
a signal processor that performs a predetermined digital signal process on the digital uplink signal.

[Supplementary Note 7]

A signal processing method performed by using a wireless access system including: a centralized control station; and an access point connected to the centralized control station through an optical network,
the signal processing method comprising:
performing a pulse width modulation process on an analog uplink signal to be transmitted from the access point to the centralized control station, thereby to generate an analog modulation signal;
converting the analog modulation signal to an optical uplink signal;
converting the optical uplink signal transmitted from the access point to the centralized control station through the optical network, to an electrical uplink signal;
performing, on the electrical uplink signal, a filtering process for extracting an analog extraction signal including a signal component corresponding to the analog uplink signal, from the electrical uplink signal;
converting the analog extraction signal to a digital uplink signal representing a signal level of the analog extraction signal by two or more bits; and
performing a predetermined digital signal process on the digital uplink signal.

[Supplementary Note 8]

A signal processing method performed by using a centralized control station connected to an access point through an optical network, wherein
the access point performs a pulse width modulation process on an analog uplink signal to be transmitted from the access point to the centralized control station, thereby to generate an analog modulation signal, and converts the analog modulation signal to an optical uplink signal, and
the signal processing method comprises:
converting the optical uplink signal transmitted from the access point to the centralized control station through the optical network, to an electrical uplink signal;
performing, on the electrical uplink signal, a filtering process for extracting an analog extraction signal including a signal component corresponding to the analog uplink signal, from the electrical uplink signal;
converting the analog extraction signal to a digital uplink signal representing a signal level of the analog extraction signal by two or more bits; and
performing a predetermined digital signal process on the digital uplink signal.

[Supplementary Note 9]

A non-transitory recording medium on which a computer program that allows a computer to execute a signal processing method is recorded, the signal processing method being performed by using a wireless access system including: a centralized control station; and an access point connected to the centralized control station through an optical network,
the signal processing method including:
performing a pulse width modulation process on an analog uplink signal to be transmitted from the access point to the centralized control station, thereby to generate an analog modulation signal;
converting the analog modulation signal to an optical uplink signal;
converting the optical uplink signal transmitted from the access point to the centralized control station through the optical network, to an electrical uplink signal;
performing, on the electrical uplink signal, a filtering process for extracting an analog extraction signal including a signal component corresponding to the analog uplink signal, from the electrical uplink signal;
converting the analog extraction signal to a digital uplink signal representing a signal level of the analog extraction signal by two or more bits; and
performing a predetermined digital signal process on the digital uplink signal.

[Supplementary Note 10]

A non-transitory recording medium on which a computer program that allows a computer to execute a signal processing method is recorded, the signal processing method being performed by using a centralized control station connected to an access point through an optical network, wherein
the access point performs a pulse width modulation process on an analog uplink signal to be transmitted from the access point to the centralized control station, thereby to generate an analog modulation signal, and converts the analog modulation signal to an optical uplink signal, and
the signal processing method includes:
converting the optical uplink signal transmitted from the access point to the centralized control station through the optical network, to an electrical uplink signal;
performing, on the electrical uplink signal, a filtering process for extracting an analog extraction signal including a signal component corresponding to the analog uplink signal, from the electrical uplink signal;
converting the analog extraction signal to a digital uplink signal representing a signal level of the analog extraction signal by two or more bits; and
performing a predetermined digital signal process on the digital uplink signal.

This disclosure is not limited to the above-described examples and is allowed to be changed, if desired, without departing from the essence or spirit of the invention which can be read from the claims and the entire specification. A wireless access system, a centralized control station, a signal processing method, and a recording medium with such changes, are also included in the technical concepts of this disclosure.

### DESCRIPTION OF REFERENCE NUMERALS

SYS Wireless access system
1 Centralized control station
11 O/E converter
12 Analog filter
13 Multibit AD converter
14 Digital signal processing unit
2 Access point
21 Antenna
22 Radio Signal processing unit
23 Signal modulator
24 Reference signal generator
E/O converter
3 Optical network
31 Optical fiber

What is claimed is:

1. A wireless access system comprising:
a centralized control station; and
an access point connected to the centralized control station through an optical network,
the access point including:
a modulator that performs a pulse width modulation process on an analog uplink signal to be transmitted from the access point to the centralized control station, thereby to generate an analog modulation signal; and
an optical signal convertor that converts the analog modulation signal to an optical uplink signal,
the centralized control station including:
an electrical signal convertor that converts the optical uplink signal transmitted from the access point to the centralized control station through the optical network, to an electrical uplink signal;
a filter that performs, on the electrical uplink signal, a filtering process for extracting an analog extraction signal including a signal component corresponding to the analog uplink signal, from the electrical uplink signal;
a digital signal convertor that converts the analog extraction signal to a digital uplink signal representing a signal level of the analog extraction signal by two or more bits; and
a signal processor that performs a predetermined digital signal process on the digital uplink signal.

2. The wireless access system according to claim 1, wherein
the access point further includes:
an antenna that receives a radio uplink signal; and
an uplink signal generator that generates, from the radio uplink signal received by using the antenna, each of a first analog uplink signal corresponding to an in-phase component of the radio uplink signal and a second analog uplink signal corresponding to a quadrature-phase component of the radio uplink signal,
the modulator includes: a first modulator that performs the pulse width modulation process on the first analog uplink signal, thereby to generate a first analog modulation signal; and a second modulator that performs the pulse width modulation process on the second analog uplink signal, thereby to generate a second analog modulation signal,
the optical signal convertor includes: a first optical signal converter that converts a first pulse width modulation signal to a first optical uplink signal; and a second optical signal converter that converts a second pulse width modulation signal to a second optical uplink signal,
the electrical signal convertor includes: a first electrical signal converter that converts the first optical uplink signal transmitted from the access point to the centralized control station through a first optical fiber included in the optical network, to a first electrical uplink signal; and a second electrical signal converter that converts the second optical uplink signal transmitted from the access point to the centralized control station through a second optical fiber included in the optical network, to a second electrical uplink signal,
the filter includes: a first filter that performs, on the first electrical uplink signal, a filtering process for extracting a first analog extraction signal including a signal component corresponding to the first analog uplink signal, from the first electrical uplink signal; and a second filter that performs, on the second electrical uplink signal, a filtering process for extracting a second analog extraction signal including a signal component corresponding to the second analog uplink signal, from the second electrical uplink signal,
the digital signal convertor includes: a first digital signal converter that converts the first analog extraction signal to a first digital uplink signal representing a signal level of the first analog extraction signal by two or more bits; and a second digital signal converter that converts the second analog extraction signal to a second digital uplink signal representing a signal level of the second analog extraction signal by two or more bits, and
the signal processor performs the predetermined digital signal process on the first and second digital uplink signals.

3. The wireless access system according to claim 1, wherein
the centralized control station further includes an analog signal convertor that converts an inputted digital reference signal to an analog reference signal, in synchronization with a predetermined clock signal,
the modulator obtains the analog reference signal from the centralized control station through the optical network, and performs the pulse width modulation process while using the analog reference signal as a comparison signal to be compared with the analog uplink signal, thereby to generate a pulse width modulation signal, and
the digital signal convertor converts the analog extraction signal to the digital uplink signal in synchronization with the clock signal.

4. The wireless access system according to claim 3, wherein the analog signal convertor converts the digital reference signal to the analog reference signal whose signal level varies discretely between two different levels, in synchronization with the clock signal.

5. The wireless access system according to claim 3, wherein
in a first period in which the optical uplink signal is transmitted from the access point to the centralized control station, the analog signal convertor converts the digital reference signal to the analog reference signal, and the modulator performs the pulse width modulation process while using the analog reference signal as the comparison signal, thereby to generate the pulse width modulation signal, and
in a second period that is different from the first time period, the analog signal convertor converts a digital downlink signal to be transmitted from the centralized control station to the access point, to an analog downlink signal, and the modulator does not generate the pulse width modulation signal.

6. A signal processing method performed by using a wireless access system including: a centralized control station; and an access point connected to the centralized control station through an optical network,
the signal processing method comprising:
performing a pulse width modulation process on an analog uplink signal to be transmitted from the access point to the centralized control station, thereby to generate an analog modulation signal;
converting the analog modulation signal to an optical uplink signal;
converting the optical uplink signal transmitted from the access point to the centralized control station through the optical network, to an electrical uplink signal;
performing, on the electrical uplink signal, a filtering process for extracting an analog extraction signal including a signal component corresponding to the analog uplink signal, from the electrical uplink signal;
converting the analog extraction signal to a digital uplink signal representing a signal level of the analog extraction signal by two or more bits; and
performing a predetermined digital signal process on the digital uplink signal.

7. A non-transitory recording medium on which a computer program that allows a computer to execute a signal processing method is recorded, the signal processing method being performed by using a wireless access system including: a centralized control station; and an access point connected to the centralized control station through an optical network,
the signal processing method including:
performing a pulse width modulation process on an analog uplink signal to be transmitted from the access point to the centralized control station, thereby to generate an analog modulation signal;
converting the analog modulation signal to an optical uplink signal;
converting the optical uplink signal transmitted from the access point to the centralized control station through the optical network, to an electrical uplink signal;
performing, on the electrical uplink signal, a filtering process for extracting an analog extraction signal including a signal component corresponding to the analog uplink signal, from the electrical uplink signal;
converting the analog extraction signal to a digital uplink signal representing a signal level of the analog extraction signal by two or more bits; and
performing a predetermined digital signal process on the digital uplink signal.
